(19) United States
(12) Patent Application Publication
(10) Pub. No.: US 2005/0252356 A1
(43) Pub. Date: Nov. 17, 2005

(54) Apparatus and work plane for cutting a material

(75) Inventor: Cesare Beccari, Bologna (IT)

Correspondence Address: YOUNG & THOMPSON, 745 SOUTH 23RD STREET, 2ND FLOOR, ARLINGTON, VA, 22202, US

(73) Assignee: Bierrebi S.p.A., Zola Predosa (Bologna) (IT)

(21) Appl. No.: 10/517,430

(22) PCT Filed: Jun. 6, 2003
(86) PCT No.: PCT/IB03/02501

§ 371 Date: Dec. 10, 2004

(30) Foreign Application Priority Data
Jun. 11, 2002 (IT) BO2002A000368

(51) Int. Cl. B26D 1/18

(52) U.S. Cl. 83/939; 83/485

(57) ABSTRACT

An apparatus (10) for cutting a material (16), in particular a fabric or the like, which is fed in the form of a continuous strip, from a respective reel (14), and cut into appropriate portions. The apparatus comprises a support frame (12), means (22) to support the material in the form of a work plane (22), on which the material is spread. Above the work plane (22) are one or more mobile cutting units (18), each with a material cutting blade (20). The work plane (22) supporting the material (16) is made from glass and is equipped with appropriate means to make the work plane elastically yielding in such a way as to perform the cutting of the material without the risk of the cutting blade damaging the work plane.

### TECHNICAL FIELD

The present invention concerns an apparatus for cutting a material, in particular an apparatus for cutting fabric or the like.

### BACKGROUND ART

In the field of fabric cutting equipments sector, apparatuses are known which have a work plane which supports the pieces of fabric to be cut, this plane consisting of a plurality of bristles, or equivalent porous material, which support the pieces and are equipped with appropriate means of suction and restraint of the pieces on the plane. These devices, which use suction means to restrain the fabric, are however somewhat complex and costly, as well as being not very suitable for making precise cuts for all the cut portions of the fabric.

Apparatuses for cutting are also provided which are equipped with cutting devices having a steel work plane. This steel work plane, however, presents considerable construction problems, in particular as regards achieving a perfectly flat surface to support the material and which is moreover affected by thermal dilation phenomena. Producing a steel work plane to support the material to be cut is, therefore, difficult and excessively expensive. Moreover, since it is not possible to implement easy systems for the uniform restraint of the material to be cut, a steel work plane does not permit accurate and precise cutting of the fabric.

The need is therefore felt for an apparatus for cutting shaped portions of material, that allows accurate and precise cutting of these portions of material, and which is, at the same time, easy to construct.

### SUMMARY OF THE INVENTION

An apparatus is therefore provided for cutting a material, in particular fabric or the like, which is cut into appropriate portions, in particular into shaped portions to make items of clothing; the apparatus comprises a support frame, means of support for the material in the form of a work plane to support the material, above which are one or more mobile cutting units, each with a cutting blade; characterised in that the material work plane is made from glass, and in that means are provided designed to make this glass work plane elastically yielding.

Thanks to the fact that the glass work plane is elastically yielding, it is possible to cut the material without the cutting blade scratching the surface of the work plane which acts as a counter surface to the blade and a support for the material to be cut.

The present invention also concerns a work plane to support a material to be cut.

The other claims describe other advantageous aspects of this apparatus and work plane.

### BRIEF DESCRIPTION OF THE DRAWINGS

The technical features and various advantageous aspects of this invention will become clearer on reading the detailed description below, referring to the attached drawings, which represent a purely indicative and non-binding embodiment, in which:

FIG. 1 shows a schematic side view of a preferred embodiment of an apparatus for cutting material according to this invention;

FIG. 2 shows a schematic side view of a detail relative to a cutting unit used in this preferred embodiment according to this invention;

FIG. 3 shows an enlarged schematic cross-section view of a portion of the material work plane, in which the structure comprising the work plane is shown;

FIG. 4 shows a schematic view from above of the material work plane;

FIG. 5 shows a schematic cross-section view along the line V-V in FIG. 4, illustrating the work plane and the means which support it;

FIG. 6 shows an enlarged schematic view of the cutting blade;

FIG. 7 shows a schematic view of the load of the blade on the work plane when the blade is positioned frontally;

FIG. 8 shows a schematic view of the load of the blade on the work plane when the blade is positioned at the side.

### DESCRIPTION OF THE PREFERRED EMBODIMENTS OF THE INVENTION

The figures show a preferred embodiment of an apparatus 10 for cutting a material 16, in particular for cutting fabric or the like.

This fabric is fed in the form of a continuous strip, from a respective reel 14, and cut into appropriately shaped portions, in particular into shaped portions to make items of clothing.

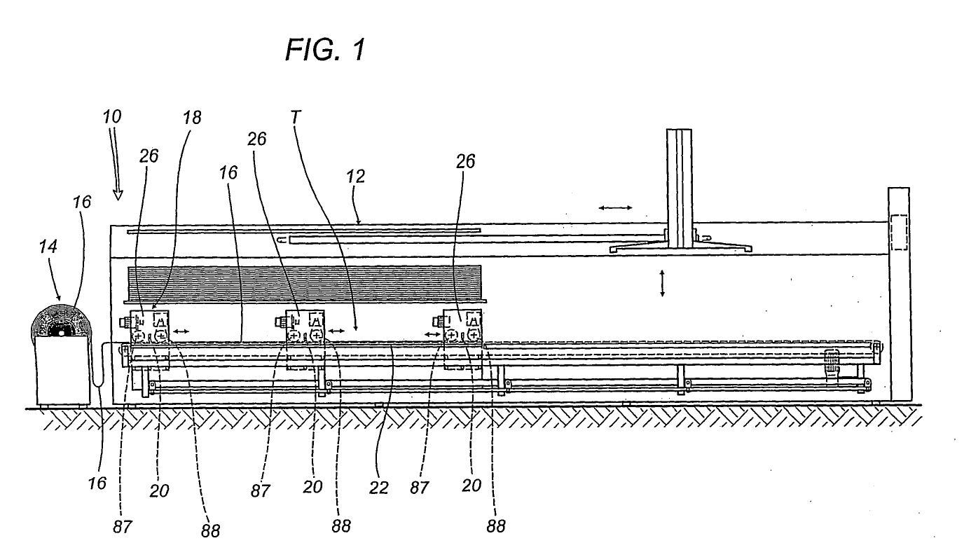

This apparatus comprises a support frame 12, means to support the material in the zone T for cutting the material into shaped portions, these means comprising a work plane 22 supporting the material 16, and on which, as shown in FIG. 1, the material is spread, preferably in a single layer.

Above the work plane 22 are one or more mobile cutting units 18, each with a cutting blade 20, each of the units covering a respective longitudinal zone of the portion or piece of the material 16, which is spread on the work plane 22 and which has to be cut. After a longitudinal portion of the material has been cut, the cut material is fed forward and a new strip of fabric is unwound from the reel 14 to provide a new portion or piece of fabric to be cut on the work plane 22, in the cutting zone T.

The apparatus and the cutting units 18, which each cut a respective longitudinal part of material, can for example be configured like those described in the international patent application WO 01/39941 by the same applicant, the contents of which must, by virtue of this indication, be considered as an integral part of this description.

According to this embodiment, the work plane 22 which supports the material 16 is advantageously made from glass, allowing the material to slide on the work plane after it has been cut into appropriate portions and when the material has to be transferred downstream towards the pick-up area, and a new portion of material to be cut is positioned in the cutting zone T, as is clearly described in the aforesaid document WO 01/39941.

The use of a work plane made from glass to support the fabric to be cut is advantageous since glass makes it possible to provide a support surface which is particularly smooth and flat and which therefore allows the fabric to be cut to slide easily on the support surface without, moreover, causing any wear or damage to the fabric to be cut.

This fabric support work plane made from glass also provides a means to counter the cutting blade 20, which by acting as a rigid counter element allows the cutting blade to perform accurate and decisive cuts separating the shaped portions of the fabric.

As can be seen by referring to FIG. 1, the fabric support work plane is positioned downstream of the fabric feed means and is supported by the frame of this apparatus, as better clarified below.

This glass work plane also provides advantageous means of restraint for this fabric.

Glass is in fact a dielectric material which becomes electrostatically charged, in particular due to the rubbing of the fabric as it slides over the surface of the work plane. This electrostatic charge on the upper surface of the glass work plane permits the material to be cut to be attracted and kept in contact with the support surface. It is therefore possible, during cutting, to maintain the fabric closely adherent to the upper surface of the work plane and the portions of fabric can thus be cut in a particularly accurate and precise manner.

Means are also provided that are designed to make this glass work plane elastically yielding under the weight of the vertical load imparted by the cutting blade.

This vertical compliance of the work plane is, advantageously, provided to the extent that it allows accurate and decisive cutting of the shaped portions of fabric and, at the same time, is such as to prevent the cutting blade from cutting into the upper surface of the blade counter plane on which the fabric to be cut is positioned.

In practice, this work plane bends due to the pressure imparted by the blade, in such a way as to present, as better clarified below, a centre line deflection f with a predefined value and sufficient to make it possible to cut the fabric without the cutting blade scratching the upper surface of the blade counter-surface and fabric support work plane and without this causing any bending breakage of this plane. In practice, the glass work plane is such that the deflection it reaches, due to the action imparted by the cutting blade, does not exceed the elastic limit of this glass and cannot therefore cause a breakage or surface fissures in this support material.

This predefined elastic compliance of the glass work plane ensures a long working life.

In a preferred and advantageous embodiment, this work plane comprises at least one upper sheet 22a, which is made from glass.

This first upper sheet 22a, made from glass, presents an upper surface 22′a which supports the fabric to be cut.

This work plane also comprises a second sheet 22b, which supports the upper sheet 22a. This second lower sheet 22c is, advantageously, also made from glass.

These first and second sheets are placed on top of each other and joined together, forming a structural element with a prevalently two-dimensional development and which is compact and vertically flexible, in such a way as to guarantee resistance suitable to support the vertical stress imparted by the cutting blade without there being any risk of breakage of the glass.

Since the distributed support of the first sheet 22a is provided by a corresponding glass sheet, a uniform expansion of the two sheets, the upper fabric support sheet and the lower sheet, is also guaranteed, preventing the formation of relative stress to the advantage of the planarity of this fabric support work plane.

As illustrated, this second lower sheet 22b also presents a lower surface 22′b which engages with the means of support of the fabric work plane and which will be better described below.

The main constituent material of glass is silica (SiO₂). To achieve the necessary hardness of the glass, amounts of 1 to 2%, in weight, of MgO (Magnesium oxide) and 0.6 to 0.8%, in weight, of AL₂O₃ (Alumina) are used.

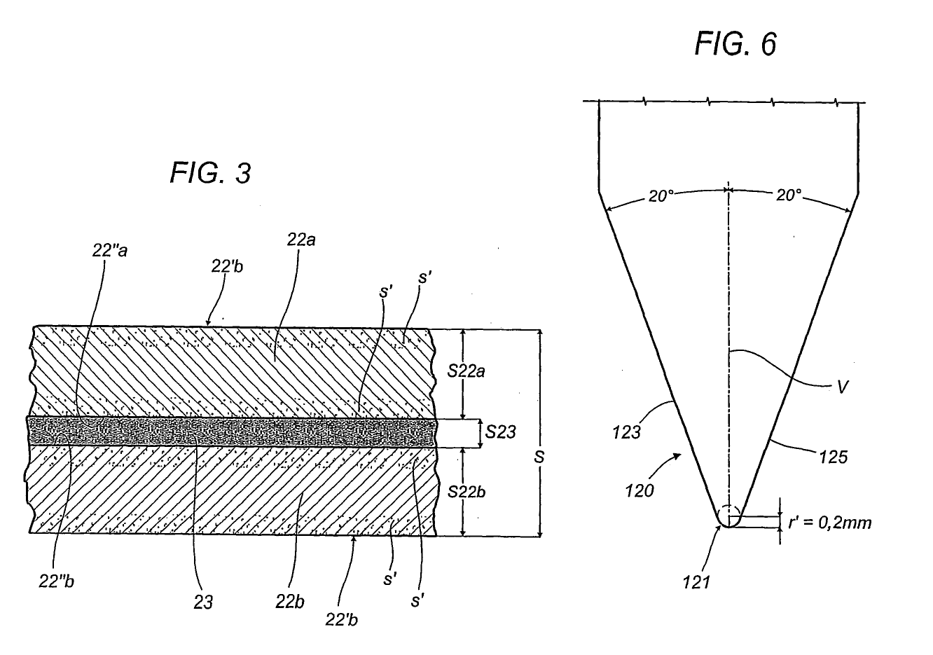

A particularly high degree of hardness is foreseen for at least one outer layer of the sheet, in particular at the outer thicknesses s′ of the sheet, as shown in FIG. 3. A degree of hardness between 800 and 850 HK is considered advantageous (where HK is the Knoop hardness number).

To achieve this feature, the sheet of glass to be surface hardened is cooled at a low temperature in air with a high humidity content.

This sheet of glass is therefore more resistant, in particular more resistant to the cutting action of the blade.

The two sheets 22a, 22b are joined together by an adhesive material 23, positioned between the opposite surfaces 22″a, 22″b of the two sheets 22a, 22b.

This adhesive layer allows horizontal microsliding between the contact surfaces of the two sheets, to the advantage of the elastic compliance of the sheet.

This adhesive material preferably consists of PVB (polyvinyl butyral), and its thickness S23. (see FIG. 3) is between 1 and 2 mm, preferably 1.5 mm.

As shown in FIG. 3, the thickness S22a of the first sheet is between around 10 and 14 mm, preferably 12 mm. The thickness S22b of the second sheet is also between around 10 and 14 mm, and is preferably 12 mm.

Overall, the thickness S of the work plane is substantially between 20 and 30 mm, and is preferably 25 mm.

Means 27 are also provided to support the fabric work plane in such a way that the elastic compliance of the work plane is contained within a predefined limit value and which prevents the superficial scratching of the work plane.

These means 27 support the work plane in such a way that—in the section between adjacent support means—it presents a predefined degree of elasticity or deflection and which remains within the limit of the elastic deformation of the work plane and which moreover makes it possible to prevent the surface scratching of the work plane.

It is possible, in this way, to provide a countering action to the cutting blade, which is sufficient to allow accurate cutting of the fabric and at the same time to prevent the surface scratching of the work plane.

Advantageously, these support means 27 of the work plane are in the form of elastically yielding support means.

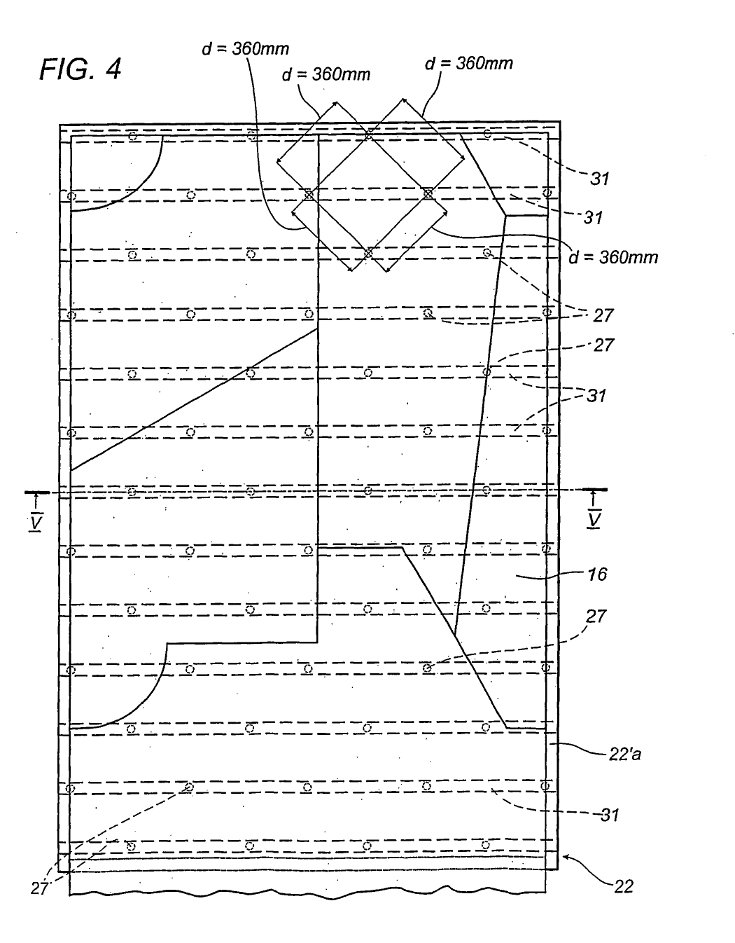

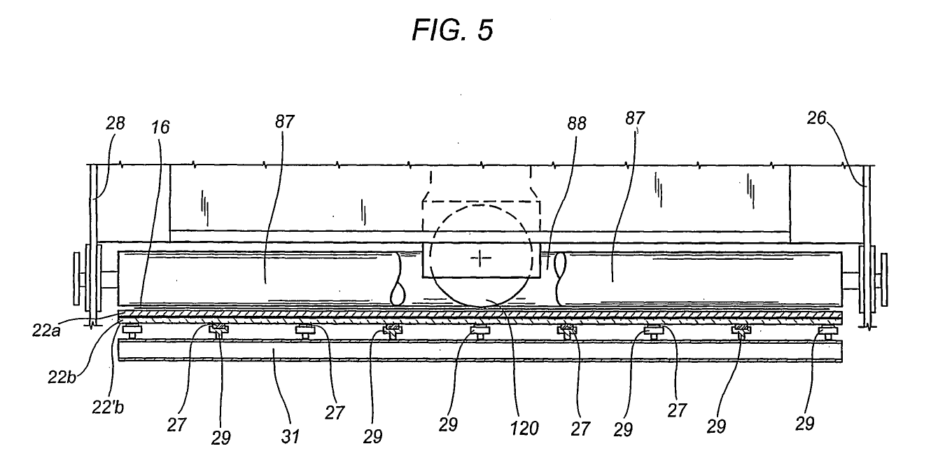

As FIGS. 4 and 5 show, these work plane support means comprise a plurality of support means 27 on which the fabric work plane rests.

As shown, in particular, in FIGS. 4 and 5, the adjacent elements of the support means are spaced at a predefined distance from each other, indicated by the reference letter d in FIG. 4.

Advantageously, this distance d can vary between 320 and 400 mm, and, as illustrated in the attached figures, is preferably 360 mm.

As clearly shown in the attached FIG. 4, these means provide supports 27 (shown with dashed lines), which are substantially pointed and distributed on the lower surface of the work plane in such a way that adjacent supports 27 represent the corners of a virtual quadrilateral (as shown in FIG. 4), in particular, according to this preferred embodiment, the corners of a square.

This provides a support structure of the work plane which allows sufficient elastic deformation to prevent the work plane from being scratched on its upper surface, and to allow accurate cutting of the shaped portions of the fabric by the blade.

As shown in FIG. 4, these support elements 27 are arranged in transverse lines at a certain distance apart. These lines are parallel to each other and at a certain longitudinal distance apart. These support elements 27 are arranged in such a way that the elements in a transverse line are positioned longitudinally between corresponding elements of the adjacent longitudinal line.

This provides a good distribution of the support elements, making it possible to support the work plane 22 in a substantially uniform manner.

In practice, the supports 27 which are substantially pointed and elastically yielding in an axial direction, i.e. in a vertical or perpendicular direction to the work plane, provide sufficient vertical flexibility, when the cutting blade passes over or close to the support (allowing the work plane to yield and prevent the glass surface from being scratched), while vertical flexibility is provided—at the centre line points between one support and the next—by the bending flexibility of the work plane. In the sections between the centre line point—between one support and the next—and the supports, the elastic flexibility is substantially an interpolation of the two types of flexibility, bending of the work plane and axial or vertical flexibility of the elastic support.

Each support element of the fabric work plane advantageously comprises a respective pad 27, made from elastomeric material, with a circular cross-section, which not only allows elastic deformation of the work plane, preventing the scratching of the glass surface, but is also sufficient to prevent the creation of peaks of stress localised in correspondence with the support points.

Other elastic means could, however, be used instead of this elastomeric pad.

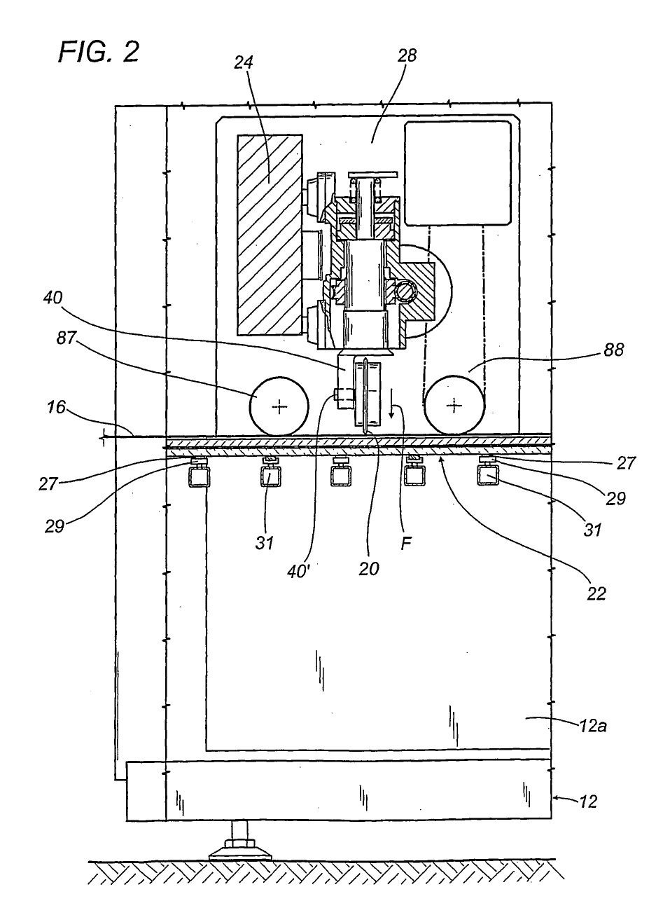

As shown in the attached FIGS. 2 and 5, each elastomeric pad 27 is supported by a cup-shaped element 29, which presents a circular cross-section housing, in metal, preferably steel, which holds the lower part of the elastomeric pad 27 and is supported by a vertical stem protruding from a corresponding transverse beam 31 of this apparatus, this beam 31 being designed to support a corresponding transverse row of support elements 27.

In particular, a plurality of these transverse beams 31 are foreseen, supporting respective rows of these support elements 27, which are arranged longitudinally at a certain distance from each other.

Fabric cutting means are also foreseen in the form of a circular blade 20, in steel, which rotates on the fabric in order to cut it.

The blade moves over the fabric work plane according to predefined linear pathways in order to cut the shaped portions of the fabric and also moves vertically, between a lowered working and fabric cutting position and a raised position—during which the blade moves, parallel to the work plane, from the end point of a cut to a subsequent start point of a new cut, without performing any cutting action during this movement.

The cutting blade 20 turns or rotates perpendicularly to the work plane 22—by rotation of its support axis—according to predefined directional angles in order to perform longitudinal, transverse and oblique cuts or cuts of any predefined conformation, also including or consisting of curved sections.

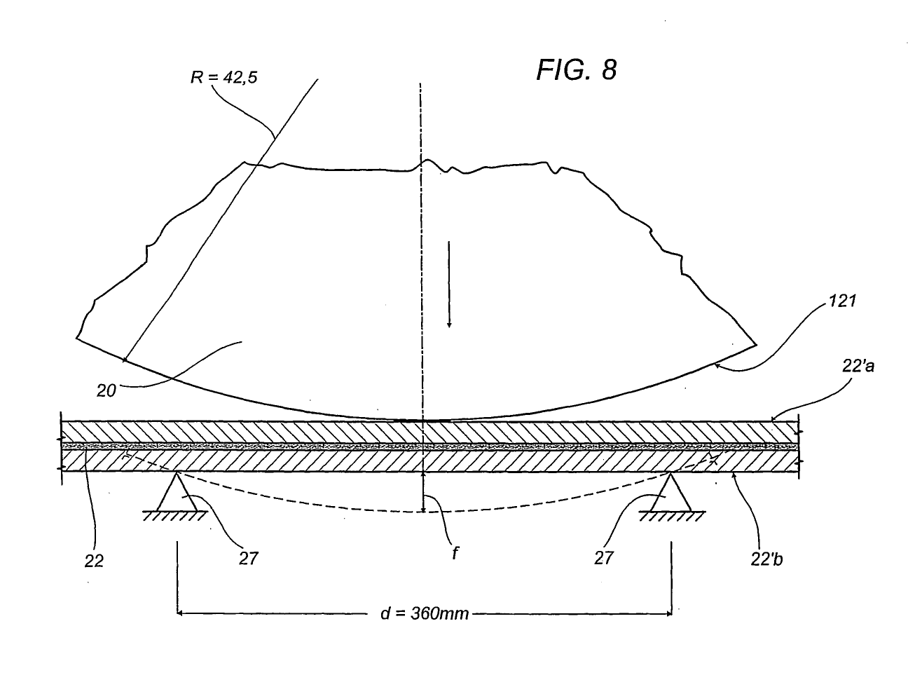

This blade presents a cutting edge 120, with a radius of curvature R′ advantageously between 30 and 50 mm, preferably 42.5 mm, as shown in FIG. 8.

As clearly shown in FIG. 6, this blade also presents a radial extremity 121 which comes into contact with and cuts the fabric and a first 123 and second 125 surface converging on the cutting extremity, in which this cutting extremity defines an arched surface advantageously having a radius of curvature r′ between 0.15 and 0.25 mm, preferably 0.2 mm, while the converging surfaces slope, respectively, at an angle between 16° and 20°, preferably 20° with respect to the vertical V.

This makes it possible to achieve a specific pressure on the fabric to be cut and which is sufficient to provide an accurate cut and at the same time a specific pressure on the material which constitutes the surface of the work plane, which advantageously remains below the breaking or cutting limit of this material and thus prevents its surface from being scratched, guaranteeing thereby a long working life of the surface and thus of the work plane.

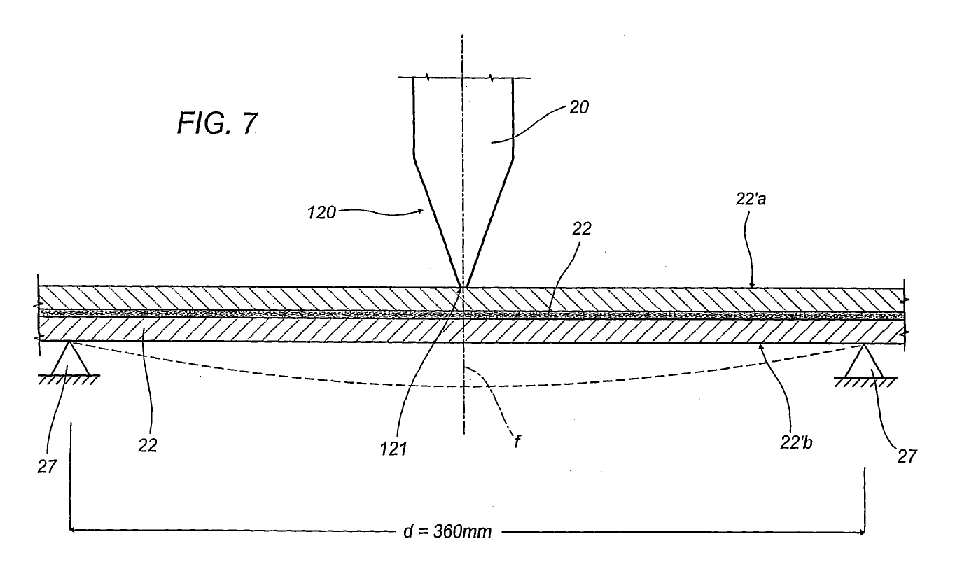

The deformation of the work plane caused by the blade 22 when it is at the centre line point between two support elements is illustrated in FIGS. 7 and 8. FIGS. 7 and 8 illustrate two limit conditions with the blade turned in angular directions at right angles to each other. The weight which the blade exerts on the work plane 22, in these load conditions, elastically deforms the work plane until it reaches a predefined deflection f at the centre line point, such as not to damage the work plane material but to provide elastic compliance that prevents any risk of surface scratching of the material.

Support means of the cutting blade are provided in the form of a vertical shaft 40 defined by the stem of a pneumatic cylinder 41, which is designed to impart a force F of the blade on the work plane 22, which is advantageously between 15 and 30 kg, and is preferably 20 kg.

These support means of the blade are suitable to bring the cutting blade into contact with the fabric, with a predefined pressure, to make the cut, by rotating the blade on its fulcrum pin 40′, and to raise the blade above the fabric just in order to move it.

The blade support means are connected to the frame of this apparatus by means of transverse beams 24, which are constrained by corresponding metal side plates 26, 28.

Appropriate means, not shown in the attached drawings; move these cutting blade support means longitudinally along the work plane.

Means are provided which rotate the blade-holder shaft 40 with respect to its vertical axis. These shaft rotation means are the same as those described in the aforesaid document WO 01/39941 and are, therefore, not described again in detail here.

For each cutting unit, means are also provided which are designed to block a corresponding portion of material while it is being cut.

These means designed to block the material to be cut are in the form of a first 87 and second 88 roller, between which the cutting blade 20 extends.

The material between the rollers 87, 88 is held taut thanks to the fact that it is blocked laterally by the restraining action of each roller on the material, pressing it against the upper surface of the work plane 22.

According to a preferred embodiment, it is also foreseen that the rollers 87 and 88, blocked in a non-rotating condition, are pulled downstream and drag the cut material with them to transfer it to a material pick-up zone.

At the same time, a new length of material is fed into the cutting zone T.

During these stages, the material slides over the upper surface of the work plane under the pressure exerted by the blocking rollers.

These first and second rollers 87, 88 are supported in a freely turning fashion by metal side plates 26, 28.

According to one aspect of this invention, the cutting blade 20 exerts a specific pressure on the fabric, which is sufficient to accurately and decisively cut this material—whatever the type and features of this fabric material to be cut—while this specific pressure is not sufficient to cause localised breaks or damage to the underlying surface of the work plane and cutting blade counter-element.

Considering glass as having an elastic modulus (Young's modulus) equal to 7×10¹⁰ PA (Pascal) and a Poisson modulus equal to 0.2 it is possible to ascertain that, on the conditions established above, under the weight of the cutting blade load, the glass plane is elastically distorted with maximum deflection f, this remaining within the range of elastic deformation, with no breakage of the work plane.

While this embodiment of the apparatus is suitable for obtaining the best result, also in terms of working life and resistance to wear, it is believed that the use of even only some or one of the above-mentioned features of the apparatus is highly advantageous.

The invention described above is subject to numerous modifications and variations, all within the scope of the inventive concept. Moreover, all the details of the invention may be substituted by technically equivalent elements.

1. An apparatus (10) for cutting a material (16), in particular fabric or the like, which is cut into appropriate portions, in particular into shaped portions for the manufacture of items of clothing; the apparatus comprising a support frame (12), means to support the material in the form of a work plane (22) for the material (16), above which are one or more mobile cutting units (18) each having a cutting blade (20); the apparatus being characterised in that the work plane (22) supporting the material (16) is made from glass; and in that means are provided which are designed to make this glass work plane elastically yielding.

2. The apparatus according to claim 1, characterised in that the work plane comprises at least one upper sheet (22a), which is made from glass and forms a support surface (22′a) for the material to be cut.

3. The apparatus according to claim 2, characterised in that the work plane comprises a second sheet (22b) which acts as a means of support for the upper sheet (22a).

4. The apparatus according to claim 3, characterised in that the second lower sheet (22b) is made from glass.

5. The apparatus according to claim 3, characterised in that the first and second sheets are placed one on top of the other and are joined together.

6. The apparatus according to claim 5, characterised in that the two sheets (22a, 22b) are joined together by means of an adhesive material (23), positioned between the opposite surfaces (22″a, 22″b) of the sheets (22a, 22b).

7. The apparatus according to claim 6, characterised in that this adhesive material consists of PVB.

8. The apparatus according to claim 2, characterised in that the thickness of the first sheet is between 10 and 14 mm, preferably 12 mm.

9. The apparatus according to claim 3, characterised in that the thickness of the second sheet is between 10 and 14 mm, preferably 12 mm.

10. The apparatus according to claim 6, characterised in that the thickness of the adhesive layer is between 1 and 2 mm, preferably 1.5 mm.

11. The apparatus according to claim 1, characterised in that the thickness of the work plane is between 20 and 30 mm, preferably around 25 mm.

12. The apparatus according to claim 1, characterised in that the outer layer of the glass sheet is harder.

13. The apparatus according to claim 12, characterised in that the hardness of the outer layer of the sheet is between 800 and 850 HK.

14. The apparatus according to claim 1, characterised in that it also comprises means (27) which support the work plane and which are designed to support the work plane in such a way that it presents a predefined elastic compliance.

15. The apparatus according to claim 1, characterised in that the support means (27) of the work plane comprise means designed to support the work plane in such a way that it presents a bending compliance.

16. The apparatus according to claim 1, characterised in that the support means (27) of the work plane comprise axially yielding means designed to provide an elastic support to the work plane (22).

17. The apparatus according to claim 1, characterised in that the support means of the work plane comprise a plurality of elements (27) supporting the work plane, which are arranged at a certain distance from each other in such a way as to allow a predefined deflection (f) of the work plane that remains within the range of elastic deformation.

18. The apparatus according to claim 17, characterised in that this distance (d) between the adjacent supports (27) is substantially between 320 and 400 mm, preferably 360 mm.

19. The apparatus according to claim 1, characterised in that the supports (27) are substantially pointed and distributed along the lower surface of the work plane (22).

20. The apparatus according to claim 19, characterised in that the adjacent supports (27) form the corners of a virtual quadrilateral.

21. The apparatus according to claim 1, characterised in that the supports (27) are arranged in transverse lines at a certain distance apart;
these lines are parallel to each other and at a certain longitudinal distance apart; the supports (27) being arranged in such a way that the elements in one transverse line are positioned longitudinally between corresponding elements of the adjacent longitudinal line.

22. The apparatus according to claim 1, characterised in that each support element of the work plane consists of a pad (27) made from elastomeric material and designed to provide the work plane with an elastic support.

23. The apparatus according to claim 22, characterised in that each support element of the work plane consists of a pad (27) with a circular cross-section.

24. The apparatus according to claim 22, characterised in that each pad (27) is supported by a cup-shaped element (29) which holds the lower part of the elastomeric pad (27).

25. The apparatus according to claim 1, characterised in that the cutting blade (20) has a cutting edge (120) with a radius of curvature between 30 and 50 mm, preferably 42.5 mm.

26. The apparatus according to claim 1, characterised in that the cutting blade (20) presents a radial extremity (121) which comes into contact with and cuts the fabric and a first (123) and a second (125) surface converging on the cutting extremity.

27. The apparatus according to claim 26, characterised in that the cutting extremity consists of an arched surface with a radius of curvature between 0.15 and 0.25 mm, preferably 0.2 mm.

28. The apparatus according to claim 26, characterised in that the converging surfaces slope at an angle of between 16° and 20°, preferably 20°.

29. The apparatus according to claim 1, characterised in that it also comprises means which block a corresponding portion of material while it is being cut, these means which block the material to be cut comprising a first (87) and a second (88) roller which roll over the material to be cut and between which the cutting blade extends.

30. The apparatus according to claim 1, characterised in that the work plane (22) forms an upper surface on which the material slides.

31. The apparatus according to claim 1, characterised in that the work plane (22) acts as a means to counter the cutting blade (20).

32. The apparatus according to claim 1, characterised in that the work plane (22) acts as a means of electrostatic restraint for the material.

33. Support plane characterised by being provided as in claim 1.
